(19) United States
(12) Patent Application Publication
(10) Pub. No.: US 2005/0024526 A1
(43) Pub. Date: Feb. 3, 2005

(54) Multi-function portable disk

(76) Inventor: Mu-Jung Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/627,699

(22) Filed: Jul. 28, 2003

(51) Int. Cl. H04N 5/225; H04N 7/00; H04N 11/00

(52) U.S. Cl. 348/373; 348/552; D16/202

(57) ABSTRACT

A multi-function portable disk includes a housing, a control unit, an image pick-up module and a display unit, wherein the control unit, the image pick-up module and the display unit are fixed in the housing. The control unit has a printed circuit board. There are a main memory element, electric components and a connector arranged on the printed circuit board. The image pick-up module includes a lens system and a viewfinder that connect with the printed circuit board. The display unit includes a display screen and a defensive glass. The portable disk has memory function and other functions, such as the function of digital camera, digital video/audio recorder, PC-camera or MP3 player.

### BACKGROUND OF THE INVENTION

1. Field of the Invention

The invention relates to a multi-function portable disk. More particularly, the invention relates to a multi-function portable disk that has the function of digital camera, digital video/audio recorder, PC-camera or MP3 player, besides the function of memory.

2. The Related Art

Besides equipping hard disk or floppy disk, the traditional computer configures other outer storage device such as portable hard disk or portable floppy disk. The size of the portable hard disk or the portable floppy disk is still large. In order to overcome said shortcoming, a portable disk is designed. The portable disk has a memory element and a USB connector. When a user intends to download data from a computer to the portable disk, or transmit data from the portable disk to a computer, he only inserts the portable disk in a USB port of a computer. The portable disk has smaller size, so that the portable disk becomes an important role for exchanging information and is used by more users.

Further there are more consumer digital peripheral devices, such as digital camera, digital video/audio recorder, or MPE3 player. A lot of consumers have more than one kind of this device, so it is very inconvenient for a user to take them. Furthermore a computer generally has only two USB ports, one connects with a mouse device, and the other is remained for the user to use. When more than one digital device is needed to connect with a computer, the user only chooses one of them to connect with the computer, so it is not convenient.

Hence, how to use the advantage of the portable disk to integrate other digital devices with the portable disk has been a problem which needs to be solved for the technical staff in this field.

### SUMMARY OF THE INVENTION

An object of the present invention is to provide a multi-function portable disk which not only has the function of memory, but also has the others, such as the function of digital camera, digital video/audio recorder, PC-camera or MP3 player.

To achieve the above objective, the present invention provides a multi-function portable disk including a housing, a control unit, an image pick-up module and a display unit, wherein the control unit, the image pick-up module and the display unit are fixed in the housing. The control unit has a printed circuit board, and there are a main memory element, electric components and a connector on the printed circuit board. The main memory element may store various data. The image pick-up module includes a lens system and a viewfinder that connect with the printed circuit board. The display unit includes a display screen and a defensive glass. Because the respective units are used mutually, for example, when the image pick-up module picks up image, it is used as a digital camera. If the multi-function portable disk connects with a computer by a cable, it is also used as a PC-camera. So that the multi-function portable disk in the present invention has other functions, such as the function of digital camera, digital video/audio recorder, PC-camera or MP3 player, besides the function of memory.

### BRIEF DESCRIPTION OF THE DRAWINGS

The present invention will be apparent to those skilled in the art by reading the following description of embodiments thereof, with reference to the attached drawing, in which:

FIG. 1 is a perspective view of the multi-function portable disk according to the present invention;

FIG. 2 is an exploded perspective view of the multi-function portable disk according to the present invention;

FIG. 3 is a perspective of the multi-function portable disk with a USB connector exposed;

FIG. 4 is a perspective view of the multi-function portable disk from other viewpoint;

FIG. 5 shows the multi-function portable disk which is mounted by a brace.

### DETAILED DESCRIPTION OF THE PREFERRED EMBODIMENT

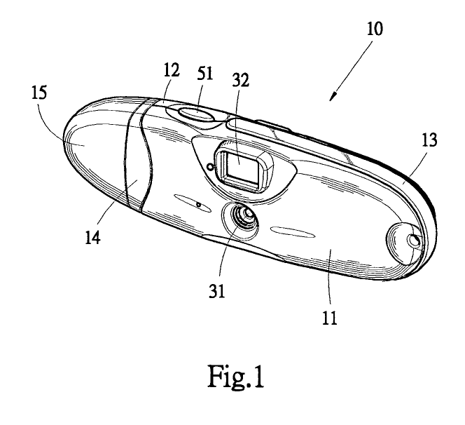

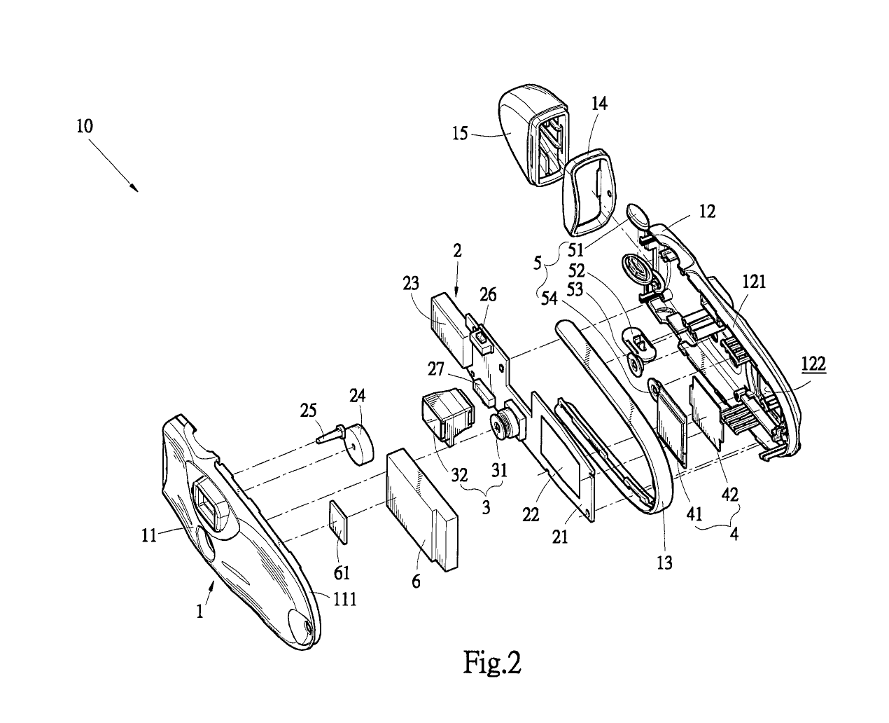

With reference to FIG. 1 and FIG. 2, a multi-function portable disk 10 of the present invention includes a housing 1, a control unit 2, an image pick-up module 3 and a display unit 4. The control unit 2, the image pick-up module 3 and the display unit 4 are set in the housing 1.

In the present invention, the housing 1 of the multi-function portable disk 10 comprises an upper cover 11 and a lower cover 12, and engagement edges 111, 121 formed respectively along the border of the upper cover 11 and the lower cover 12. There is a U-shape noose 13 that can engage with the upper cover 11 and the lower cover 12 to make them be fastened together. A sheath 14 and a cover 15 are detachable with the housing 1. The sheath 14 which is hollow engages with the upper cover 11 and the lower cover 12 at the side in which the noose 13 doesn't engage with he upper cover 11 and the lower cover 12. The cover 15 is set in the end of the multi-function portable disk 10.

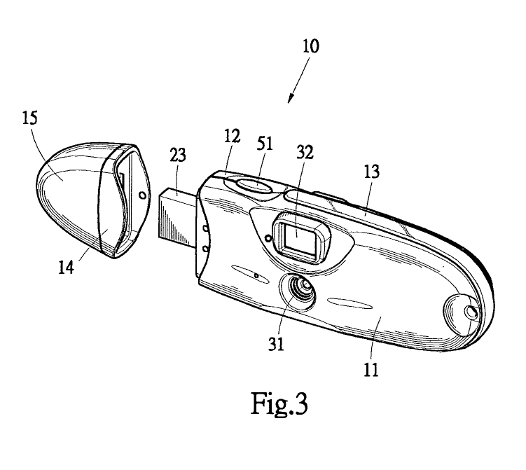

The control unit 2 includes a printed circuit board 21 on which a main memory element 22, electric components and a connector 23 are mounted. The connector 23 is placed in the side where the sheath 14 is located. FIG. 3 is a three-dimensional appearance view of the multi-function portable disk 10 in which the USB connector 23 is exposed. The USB connector 23 can be held in the cover 15.

The image pick-up module 3 which connects with the printed circuit board 21 comprises a lens system 31 and a viewfinder 32. An image sensor is mounted in the lens system 31. The image sensor picks up image data. The image data is transmitted in the circuit of the printed circuit board 21 and then temporarily stored in the main memory element 22. The viewfinder is provided for a user to view the scenes and take the scene that he desires.

Besides, the display unit 4 of the multi-function portable disk 10 includes a display screen 41 and a defensive glass 42. In the present embodiment, the display screen 41 adopts an LCD screen. There is an opening 122 in appropriate place of the lower cover 12. The user may watch the information shown in the display screen 41, such as image taken by the image pick-up module 3, or states and functions provided by the multi-function portable disk 10 for selection.

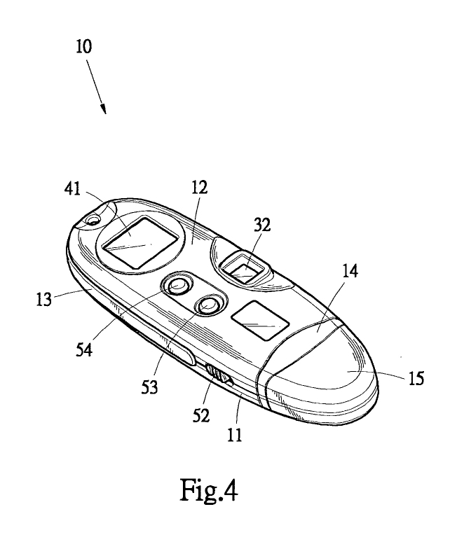

With reference to FIG. 2 and FIG. 4, there is a button group 5 through which the user can select various functions of the multi-function portable disk 10. The button group 5 of the embodiment comprises a first button 51, a second button 52, a third button 53 and a fourth button 54. The first button 51 is set in a long lateral of the housing 1 and connects with a push switch 26 fixed on the printed circuit board 21. When the user pushes the first button 51, he will start/stop the image pick-up module 3. The second button 52 is set in the opposite long lateral and connects with a power switch 27 which is fixed on the printed circuit board 21, so the power may be started through the second button 52. The third button 53 and the fourth button 54 are located in the lower cover 12 and both connect with the printed circuit board 21. The user can select among various mode through the third button 53, such as digital camera mode, digital video/audio recorder mode, or PC-camera mode. The user may start the backlight source of the display screen 41 through the fourth button 54.

There is a rechargeable battery 6, such as Li-Ion battery, in the portable disk 10, adhered to the upper cover 11 by adhesive means. A buzzer 24 and a light pipe 25 separately connect with the printed circuit board 21. The light pipe 25 delivers light from LED that is configured in the printed circuit board 21 to the housing 1 and shows that the multi-function portable disk 10 is running or not.

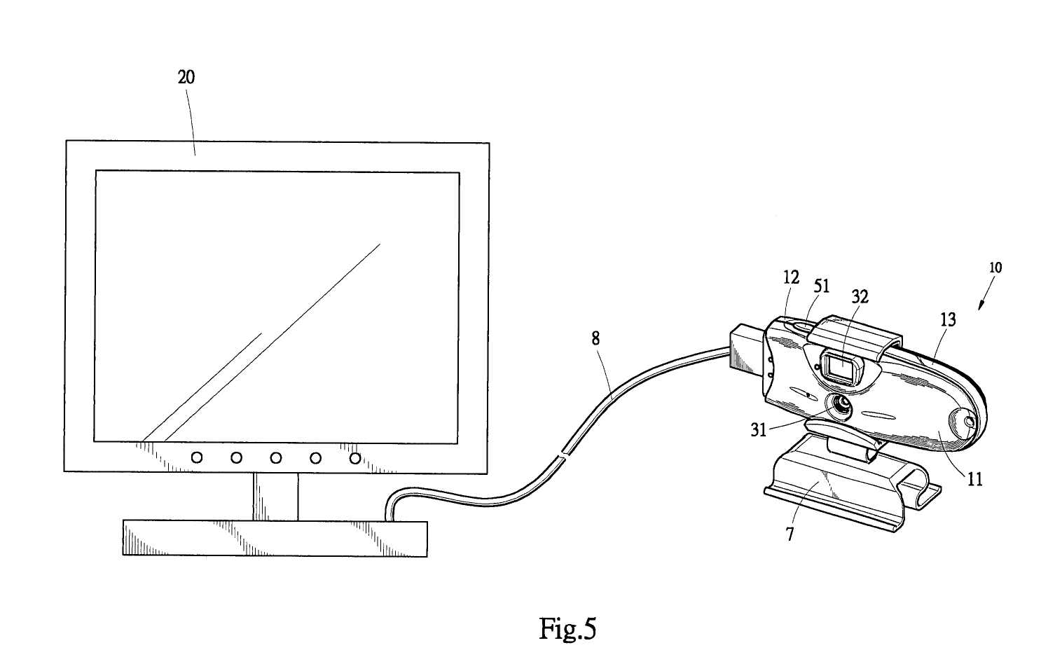

With reference to FIG. 1 and FIG. 3, when the user only utilizes the multi-function portable 10 to store data, he detaches the cover 15 from the housing 1. The connector 23 is exposed and then connected with a USB port of a computer. Accordingly, the data in the computer can be transmitted to the main memory element 22 of the multi-function portable disk 10. If the multi-function portable disk 10 runs in the image pick-up mode, the image information is picked up by the lens system 31 and stored in the main memory element 22, so the function of digital camera or digital video/audio recorder is achieved. In case that the user intends to transmit the image information in the main memory element to other memory element or print it, he only connects the connector 23 with a computer 20 directly (as shown in FIG. 5). No other apparatuses or software are required, so that the portable disk is very convenient for user.

With reference to FIG. 5, the multi-function portable disk 10 may be mounted by a brace 7. There is a cable 8 that connects the connector 23 of the multi-function portable disk 10 with a USB port of the computer 20. When the user selects the PC-camera mode, the lens system 31 and the viewfinder 32 will pick up moving pictures, so the multi-function portable disk 10 can be used in the video-meeting.

Multi-media play software, such as MP3 play software, is installed in the control unit 2, and an earphone is also configured to the multi-function portable disk 10, so the multi-function portable disk 10 is also used as an MP3 player.

According to the above-mentioned description about the multi-function portable disk, the various units share mutually, so it is possible to provide a multi-function portable disk which not only has the function of memory, but also has other functions, such as the function of digital camera, digital video/audio recorder, PC-camera or MP3 player.

Although the present invention has been filly described by way of the example with reference to the accompanying drawings, it is to be noted that various changes and modification will be apparent to those skilled in the art. Therefore, unless otherwise such changes and modifications depart from the scope of the present invention, they should be construed as being included therein.

1. a multi-function portable disk, comprising:
a housing;
a control unit which is fixed in said housing including a printed circuit board on which there are a main memory element, electric components and a connector;
an image pick-up module that includes a lens system and a viewfinder connecting with said printed circuit board; and
a display unit that includes a display screen and a defensive glass being mounted in said housing.

2. The multi-function portable disk as claimed in claim 1, wherein the housing includes:
an upper cover having an engagement edge;
a lower cover having an engagement edge; and
a noose engaging the engagement edges of the upper cover and the lower cover to make said covers be fastened.

3. The multi-function portable disk as claimed in claim 2, further comprising
a sheath which is hollow engaging with one side of the upper cover and the lower cover; and
a cover detachable engaging with the sheath.

4. The multi-function portable disk as claimed in claim 1, wherein the display unit includes a display screen and a defensive glass.

5. The multi-function portable disk as claimed in claim 4, wherein the display screen is an LCD screen.

6. The multi-function portable disk as claimed in claim 1, further comprising:
a first button being set in a long lateral of the housing to start/stop the image pick-up module;
a second button being set in other long lateral of the housing to start power;
a third button connected with the printed circuit board to choose working mode; and
a fourth button connected with the printed circuit board to make the backlight source of the display unit run.

7. The multi-function portable disk as claimed in claim 1, further comprising a buzzer connected with the printed circuit board.

8. The multi-function portable disk as claimed in claim 1, further comprising a rechargeable battery in the housing.

9. The multi-function portable disk as claimed in claim 1, further comprising a brace on which the multi-function portable disk is mounted.

10. The multi-function portable disk as claimed in claim 1, further comprising a multi-media play software installed in the control unit and an earphone configured to the multi-function portable disk.

11. The multi-function portable disk as claimed in claim 10, wherein the multi-media play software is MP3 play software.
